(19) United States
(12) Patent Application Publication
(10) Pub. No.: US 2015/0166839 A1
(43) Pub. Date: Jun. 18, 2015

(54) POLISHING COMPOSITION AND SUBSTRATE FABRICATION METHOD USING SAME

(71) Applicant: FUJIMI INCORPORATED, Kiyosu-shi, Aichi (JP)

(72) Inventors: Megumi Taniguchi, Kiyosu-shi (JP); Hitoshi Morinaga, Kiyosu-shi (JP); Masayuki Serikawa, Kiyosu-shi (JP)

(73) Assignee: FUJIMI INCORPORATED, Kiyosu-shi, Aichi (JP)

(21) Appl. No.: 14/409,278

(22) PCT Filed: Jun. 17, 2013
(86) PCT No.: PCT/JP2013/066611

§ 371 Date: Dec. 18, 2014

(30) Foreign Application Priority Data
Jun. 19, 2012 (JP) 2012-137979

(51) Int. Cl. C09G 1/02

(52) U.S. Cl. CPC C09G 1/02

(57) ABSTRACT

A polishing composition contains abrasive grains, a surface adsorptive agent, and water, and is used for polishing an object formed of a crystalline metallic compound. The polishing composition reduces defects on a polished surface of the object compared to a composition obtained by excluding the surface adsorptive agent from the polishing composition.

### TECHNICAL FIELD

The present invention relates to a polishing composition to be used for polishing an object formed of a crystalline metallic compound, and a method for producing a substrate using the composition.

### BACKGROUND ART

Known materials of substrates for optical devices and materials of substrates for power devices include, for example, oxides, such as aluminum oxide (e.g., sapphire), silicon oxide, gallium oxide, and zirconium oxide, nitrides, such as aluminum nitride, silicon nitride, and gallium nitride, and carbides, such as silicon carbide. Substrates or films formed of such materials are generally stable to chemical actions such as oxidation, complexation, and etching, and therefore cannot be easily processed by polishing. For this reason, such substrates are generally processed by grinding or cutting using hard materials. However, processing by grinding or cutting could not have provided highly smooth surfaces.

Traditionally, it has been known that a sapphire substrate is polished using a polishing composition containing colloidal silica at a relatively high concentration to obtain a smoother surface (see, for example, Patent Document 1). However, using high concentration colloidal silica has a problem of an increased polishing cost. Also, using a smaller amount of colloidal silica to reduce costs has a problem of generation of surface defects, such as orange peel defects.

### PRIOR ART DOCUMENT

### Patent Document

Patent Document 1: Japanese Laid-Open Patent Publication No. 2008-44078

### SUMMARY OF THE INVENTION

### Problems that are to be Solved by the Invention

The present invention has been made, with a focus on the amount of a surface adsorptive agent adsorbed to abrasive grains, based on the finding of a polishing composition capable of suppressing defects on a polished surface of an object.

It is an objective of the present invention to provide a polishing composition that is used for polishing an object formed of a crystalline metallic compound and is capable of suppressing defects on a polished surface of the object. Another objective of the present invention is to provide a method for producing a substrate using the composition.

### Means for Solving the Problem

In order to achieve the above objectives and in accordance with an aspect of the present invention, a polishing composition is provided that contains abrasive grains and water and is used for polishing an object formed of a crystalline metallic compound. The polishing composition further contains a surface adsorptive agent. The polishing composition reduces defects on a polished surface of the object compared to a composition obtained by excluding the surface adsorptive agent from the polishing composition.

It is preferable that the surface adsorptive agent is at least one selected from the group consisting of a vinyl polymer, a polyalkylene oxide, and a copolymer of a polyalkylene oxide and an alkyl group or an alkylene group.

It is preferable that the abrasive grains and the surface adsorptive agent are selected so as to satisfy the requirement that when a first suspension is prepared that contains abrasive grains and a surface adsorptive agent that are of the same types and in the same contents as those of the abrasive grains and the surface adsorptive agent in the polishing composition, 15% by mass or more of the surface adsorptive agent in the suspension is adsorbed to the abrasive grains in the suspension.

It is preferable that the surface adsorptive agent is selected so as to satisfy the requirement that when a second suspension is prepared that contains particles formed of the same metallic compound as that forming the object to be polished in the same content as that of the abrasive grains in the polishing composition and a surface adsorptive agent of the same type and in the same content as those of the surface adsorptive agent in the polishing composition, the amount of the surface adsorptive agent adsorbed to the metallic compound particles in the second suspension is smaller than the amount of the surface adsorptive agent adsorbed to the abrasive grains in the first suspension.

It is preferable that the abrasive grains are at least one selected from the group consisting of silicon oxide, aluminum oxide, zirconium oxide, cerium oxide, and titanium oxide.

It is preferable that the object to be polished is a single crystal substrate formed of a metal oxide, a metal nitride, or a metal carbide.

It is preferable that the object to be polished is at least one selected from the group consisting of aluminum oxide, aluminum nitride, silicon oxide, silicon nitride, silicon carbide, gallium oxide, gallium nitride, and zirconium oxide.

In accordance with another aspect of the present invention, a method for producing a polished substrate is provided that includes polishing a substrate formed of a crystalline metallic compound using the polishing composition according the above aspects.

### Effect of the Invention

The present invention succeeds in suppressing defects on a polished surface of an object formed of a crystalline metallic compound.

### BRIEF DESCRIPTION OF THE DRAWINGS

FIG. 1 is a graph illustrating the amounts adsorbed to silica and alumina of a surface adsorptive agent contained in polishing compositions of examples of the present invention and a comparative example; and

FIG. 2 is a graph illustrating polishing rates and the number of orange peel defects generated according to the polishing compositions of the examples and comparative example.

### MODES FOR CARRYING OUT THE INVENTION

One embodiment of the present invention will now be described.

A polishing composition according to the present embodiment contains at least a surface adsorptive agent, abrasive grains, and water. The polishing composition is used for polishing an object formed of a crystalline metallic compound. In consideration of low chances of adherence of particles, the surface of the object to be polished is preferably hydrophilic. In consideration of few impurities, the object to be polished is more preferably formed of a single crystal material. Specific examples of the object to be polished include ceramics like oxides, such as aluminum oxide, silicon oxide, gallium oxide, and zirconium oxide, nitrides, such as aluminum nitride, silicon nitride, and gallium nitride, and carbides, such as silicon carbide. In particular, the polishing composition is preferably used for polishing an object formed of a material such as aluminum oxide, especially sapphire, which is stable to chemical actions such as oxidation, complexation, and etching. The form of silicon oxide is not particularly limited and may be quartz or glass. The object polished with the polishing composition may be used in any application such as materials for optical devices, materials for power devices, or compound semiconductors. The form of the polishing target is not particularly limited and may be a substrate, a film, or other molded members.

Specific examples of the abrasive grains in the polishing composition include particles formed of silicon oxide, aluminum oxide, zirconium oxide, cerium oxide, or titanium oxide. Of them, aluminum oxide and silicon oxide are advantageous in that they are relatively easily available and can provide a highly smooth surface with few defects in polishing using a polishing composition. As described later, it is preferable that the adsorbability of the surface adsorptive agent to an object to be polished is lower than the adsorbability of the surface adsorptive agent to the abrasive grains, and so the abrasive grains are preferably formed of a material different from that of the object.

The content of the abrasive grains in the polishing composition is preferably 0.01% by mass or more, and more preferably 0.1% by mass or more. As the content of the abrasive grains increases, the polishing rate of the object with the polishing composition is improved.

The content of the abrasive grains in the polishing composition is preferably 50% by mass or less, and more preferably 40% by mass or less. As the content of the abrasive grains decreases, the production cost of the polishing composition is reduced and a surface with few scratches is easily obtained by polishing using the polishing composition.

The average primary particle diameter of the abrasive grains in the polishing composition is preferably 5 nm or more, more preferably 10 nm or more, and further preferably 20 nm or more. As the average primary particle diameter of the abrasive grains increases, the polishing rate of the object with the polishing composition is improved.

The average primary particle diameter of the abrasive grains in the polishing composition is preferably 2 μm or less, more preferably 500 nm or less, and further preferably 200 nm or less. As the average primary particle diameter of the abrasive grains decreases, a surface with few defects and small roughness is easily obtained by polishing using the polishing composition. The average primary particle diameter value of the abrasive grains is calculated, for example, based on the specific surface area measured by the BET method. The specific surface area of the abrasive grains is measured by using, for example, “Flow Sorb II 2300” made by Micromeritics Instrument Corporation.

The surface adsorptive agent adsorbs to the surface of the abrasive grains or the surface of the object to be polished, functioning to suppress surface defects on the polished object. The surface adsorptive agent is a compound that is adsorptive to the surface of the abrasive grains or the surface of the object to be polished. As long as a polishing composition containing the compound can reduce surface defects on the polished object compared to a composition obtained by excluding the same compound from the polishing composition, the surface adsorptive agent is not particularly limited. For example, a water-soluble polymer, which has a strong function to suppress surface defects, is preferably used. Specific examples of the surface adsorptive agent in the polishing composition include a vinyl polymer, a polyalkylene oxide, and a copolymer of a polyalkylene oxide and an alkyl group or an alkylene group. Examples of a vinyl polymer include a polyvinyl alcohol, a polyvinylpyrrolidone, and a n-polyvinyl formamide. Examples of a polyalkylene oxide include a polyethylene glycol (PEG), a polyethylene oxide (PEO), a polypropylene glycol, a polypropylene oxide, and a copolymer thereof. The surface adsorptive agent may be a copolymer with another polymer containing the above polymer in the structure. The surface adsorptive agent may also be a compound containing a hydrophilic group, such as a carboxylic acid group, a sulfonic acid group, and a phosphonic acid group. One surface adsorptive agent may be used alone, or two or more surface adsorptive agents may be used in combination.

The weight average molecular weight of the surface adsorptive agent in the polishing composition is determined so that a polishing composition containing the surface adsorptive agent reduces surface defects on the polished object compared to a composition obtained by excluding the surface adsorptive agent from the polishing composition. The weight average molecular weight is accordingly selected in consideration of the types of the surface adsorptive agent, the abrasive grains, and the object to be polished and the combination thereof. For example, when the surface adsorptive agent is a polyethylene glycol, a polyacrylic acid, a polyvinylpyrrolidone, or a polyvinyl alcohol, the abrasive grains are silica, and the object to be polished is alumina, the surface adsorptive agent in the polishing composition has a weight average molecular weight of preferably 500 or more, and more preferably 5,000 or more. As the weight average molecular weight of the surface adsorptive agent increases, a protective film that suppresses the generation of defects is easily formed on the surface of the abrasive grains and the surface of the object to be polished. Therefore, the number of surface defects caused by polishing processing is remarkably reduced. In addition, the polishing rate is improved.

The weight average molecular weight of the surface adsorptive agent in the polishing composition is also preferably 1,000,000 or less, and more preferably 500,000 or less. As the weight average molecular weight of the surface adsorptive agent decreases, a protective film that suppresses the generation of defects is easily formed on the surface of the object to be polished. Therefore, the number of surface defects caused by polishing processing is more greatly reduced.

The content of the surface adsorptive agent in the polishing composition is preferably 0.002% by mass or more, more preferably 0.004% by mass or more, and further preferably 0.006% by mass or more. As the content of the surface adsorptive agent in the polishing composition increases, a protective film reliable to suppress the generation of defects is easily formed on the surface of the object to be polished. Therefore, the number of surface defects caused by polishing processing is more greatly reduced.

The content of the surface adsorptive agent in the polishing composition is also preferably 0.5% by mass or less, more preferably 0.2% by mass or less, and further preferably 0.1% by mass or less. As the content of the surface adsorptive agent in the polishing composition decreases, the decrease in the polishing rate of the object due to the protective film is more strongly prevented.

To polish an object by using the polishing composition at a high polishing rate with suppressing the generation of surface defects, preferably the surface adsorptive agent contained in the polishing composition demonstrates predetermined adsorbability to the abrasive grains or the object.

More specifically, it is desired that the abrasive grains and the surface adsorptive agent are selected so as to satisfy the requirement that when a first suspension is prepared that contains abrasive grains and a surface adsorptive agent that are of the same types and in the same contents as those of the abrasive grains and the surface adsorptive agent in the polishing composition, preferably 5% by mass or more, more preferably 15% by mass or more, and further preferably 50% by mass or more of the surface adsorptive agent in the suspension is adsorbed to the abrasive grains in the suspension. As the amount of the surface adsorptive agent adsorbed to the abrasive grains increases, the abrasive grains are less likely to be adsorbed to the object to be polished. As a result, more surface defects are suppressed. The size of the abrasive grains used for determining the adsorbability is not particularly limited. Using abrasive grains formed of fine particles that can be suspended in an aqueous solution is preferable, and using abrasive grains having the same size as that of the abrasive grains in the polishing composition is more preferable.

Also, it is preferable that the surface adsorptive agent is selected so as to satisfy the requirement that when a second suspension is prepared that contains particles formed of the same metallic compound as that forming the object to be polished in the same content as that of the abrasive grains in the polishing composition and a surface adsorptive agent of the same type and in the same content as those of the surface adsorptive agent in the polishing composition, 5% by mass or more of the surface adsorptive agent in the second suspension is adsorbed to the metallic compound particles in the second suspension. It is more preferable that the surface adsorptive agent is selected so as to satisfy the requirement that the amount of the surface adsorptive agent adsorbed to the metallic compound particles in the second suspension is smaller than the amount of the surface adsorptive agent adsorbed to the abrasive grains in the first suspension. The size of the metallic compound particles used for determining the adsorbability is not particularly limited. Using a metallic compound in the form of fine particles that can be suspended in an aqueous solution is preferable, and using metallic compound particles having an average primary particle diameter of 5 to 1,000 nm is more preferable.

As the adsorbability of the surface adsorptive agent to the abrasive grains or the metallic compound particles increases, the abrasive grains are less likely to be adsorbed to the object to be polished. As a result, more surface defects are suppressed. Also, when the object to be polished is formed of a metallic compound and has a hydrophilic surface, the surface adsorptive agent may be adsorbed to not only the abrasive grains but also to the surface of the object. When a larger amount of the surface adsorptive agent is adsorbed to the abrasive grains than to the metallic compound particles, the action of the surface adsorptive agent to form a protective film on the object to be polished is reduced, and as a result, the object can be polished at a high polishing rate.

The method of measuring the adsorbability of the surface adsorptive agent in the polishing composition to the abrasive grains and the method of measuring the adsorbability of the surface adsorptive agent to the object to be polished are not particularly limited. Preferably, the methods are in the same conditions. For the method of measuring the adsorbability of the surface adsorptive agent to the abrasive grains, first, for example, the abrasive grains and the surface adsorptive agent are mixed in water to prepare a mixture (suspension). An additive such as a pH adjusting agent may be added to the mixture as appropriate. The mixture is shaken at room temperature (24° C.) for enough time for the surface adsorptive agent to be adsorbed to the abrasive grains, e.g., 1 to 24 hours. Then, the abrasive grains are separated from the supernatant solution by a known method such as centrifugation and filtration. The measurement of total organic carbon (TOC) in the remnant supernatant solution provides the amount of the surface adsorptive agent remaining in the supernatant solution. From the ratio of the amount of the surface adsorptive agent remaining in the aqueous solution to the total amount added of the surface adsorptive agent, the final amount of the surface adsorptive agent adsorbed to the abrasive grains can be determined. For the method of measuring the adsorbability of the surface adsorptive agent to the object to be polished, the adsorbability can be measured in the same conditions as above, by using particles formed of the same metallic compound as the metallic compound forming the polishing target instead of the abrasive grains.

As described above, the polishing composition according to the present embodiment contains a surface adsorptive agent that has adsorbability to the surface of the abrasive grains or the surface of the object to be polished. The polishing composition reduces surface defects on the polished object compared to a composition obtained by excluding the surface adsorptive agent from the polishing composition. To polish an object by using the polishing composition at a high polishing rate with suppressing the generation of surface defects, a compound having the predetermined adsorbability described above to the abrasive grains or the object is selected and used as the surface adsorptive agent in the polishing composition. More specifically, it is preferable that the abrasive grains and the surface adsorptive agent are selected so as to satisfy the requirement that when a first suspension is prepared that contains abrasive grains and a surface adsorptive agent that are of the same types and in the same contents as those of the abrasive grains and the surface adsorptive agent in the polishing composition, 5% by mass or more, 15% by mass or more, or 50% by mass or more of the surface adsorptive agent in the suspension is adsorbed to the abrasive grains in the suspension. Also, it is more preferable that the surface adsorptive agent is selected so as to satisfy the requirement that when a second suspension is prepared that contains particles formed of the same metallic compound as that forming the object to be polished in the same content as that of the abrasive grains in the polishing composition and a surface adsorptive agent of the same type and in the same content as those of the surface adsorptive agent in the polishing composition, the amount of the surface adsorptive agent adsorbed to the metallic compound particles in the second suspension is smaller than the amount of the surface adsorptive agent adsorbed to the abrasive grains in the first suspension. This permits the object to be polished at a high polishing rate and surface defects on the polished object to be suppressed.

When the content of abrasive grains is reduced in a general polishing composition, sometimes fine dents like those in orange peel are formed on the surface of an object after being polished by using the polishing composition. In such cases, if polishing is continued, the abrasive grains are attached to recessed portions defining the fine dents, leaving the recesses on the surface of the object and possibly increasing defects. In this regard, the polishing composition according to the present embodiment is capable of eliminating the recesses on the surface of the object as the surface adsorptive agent is attached to the abrasive grains.

The polishing composition of the present embodiment is used, for example, for producing a substrate formed of a crystalline metallic compound. When polishing the surface of a substrate formed of a crystalline metallic compound, with supplying the polishing composition to the surface of the substrate, a polishing pad is pressed against the substrate surface and the substrate and the polishing pad are rotated. At that stage, the surface of the substrate is polished by the physical action of friction between the polishing pad and the surface of the substrate. The surface of the substrate is also polished by the physical action of friction between the abrasive grains and the surface of the substrate.

The present embodiment described in detail above has the following advantageous effects.

(1) The polishing composition contains a specific surface adsorptive agent and therefore is capable of suppressing defects on a polished surface of an object.

(2) When the surface adsorptive agent in the polishing composition is at least one selected from the group consisting of a vinyl polymer, a polyalkylene oxide, and a copolymer of a polyalkylene oxide and an alkyl group or an alkylene group, the object is polished at a higher polishing rate and in addition, more surface defects are suppressed.

(3) When the abrasive grains and the surface adsorptive agent are selected so as to satisfy the requirement that when a first suspension is prepared that contains abrasive grains and a surface adsorptive agent that are of the same types and in the same contents as those of the abrasive grains and the surface adsorptive agent in the polishing composition, 5% by mass or more, 15% by mass or more, or 50% by mass or more of the surface adsorptive agent in the suspension is adsorbed to the abrasive grains in the suspension, the object is polished at a higher polishing rate and in addition, more surface defects are suppressed.

(4) When the surface adsorptive agent is selected so as to satisfy the requirement that when a second suspension is prepared that contains particles formed of the same metallic compound as that forming the object to be polished in the same content as that of the abrasive grains in the polishing composition and a surface adsorptive agent of the same type and in the same content as those of the surface adsorptive agent in the polishing composition, the amount of the surface adsorptive agent adsorbed to the metallic compound particles in the second suspension is smaller than the amount of the surface adsorptive agent adsorbed to the abrasive grains in the first suspension, the object is polished at a higher polishing rate and in addition, more surface defects are be suppressed.

(5) A compound having a specific adsorbability to the abrasive grains and the object to be polished is used as the surface adsorptive agent in the polishing composition. A person skilled in the art can select, out of many types of known surface adsorptive agents and abrasive grains, a combination of a surface adsorptive agent and abrasive grains that can polish an object at a high polishing rate and simultaneously can suppress surface defects on the polished object. A person skilled in the art can also determine the amount of use of the surface adsorptive agent and the abrasive grains without conducting a particular polishing experiment.

(6) The polishing composition according to the present embodiment improves the action of suppressing surface defects. Therefore, by decreasing the amount of use of the abrasive grains, polishing costs are reduced.

The embodiment described above may be modified as follows.

The polishing composition may contain a known additive such as a preservative agent and a fungicidal agent, if necessary.

The polishing composition may be in a concentrated form at the time of production and selling. More specifically, the polishing composition may be produced and sold in the form of an undiluted solution.

The polishing composition may be prepared by diluting an undiluted solution of a polishing composition with water.

The respective components contained in the polishing composition may be filtered through a filter immediately before the production. The polishing composition may be filtered through a filter immediately before the use. The filtration removes large impurities in the polishing composition to improve the quality.

A polishing pad used in the polishing method using the polishing composition is not particularly limited. For example, a nonwoven type and a suede type may be used.

The polishing composition having been used to polish a substrate may be collected and reused (recycled). More specifically, the used polishing composition having been discharged from a polishing machine may be collected in a tank and resupplied to the polishing machine from the tank. This reduces the need for disposing the used polishing composition as a waste and therefore reduces the impact on the environment. In addition, if the amount of use of the polishing composition is reduced, the production cost of substrates is also reduced.

When the polishing composition is recycled, it is preferable to replenish at least any of the components of the polishing composition, such as the surface adsorptive agent, having been reduced in the amount through consumption or loss during the use in polishing substrates.

The abrasive grains in the polishing composition may have a spherical shape or a non-spherical shape. Specific examples of the non-spherical shapes include a cocoon shape having a constricted central portion, a spiky shape having a surface with projections, and a rugby ball shape.

The following are technical ideas that can be understood from the embodiment and modifications described above.

(I) A method for producing a polishing composition to be used for polishing an object formed of a crystalline metallic compound, comprising:

selecting abrasive grains and a surface adsorptive agent; and

mixing the selected abrasive grains and surface adsorptive agent with water to prepare a polishing composition containing the abrasive grains, the surface adsorptive agent, and the water, wherein the step of selecting abrasive grains and a surface adsorptive agent is carried out

so as to satisfy the requirement that when a first suspension is prepared that contains abrasive grains and a surface adsorptive agent that are of the same types and in the same contents as those of the abrasive grains and the surface adsorptive agent in the polishing composition, 15% by mass or more of the surface adsorptive agent in the suspension is adsorbed to the abrasive grains in the suspension, and

so as to satisfy the requirement that when a second suspension is prepared that contains particles formed of the same metallic compound as that forming the object to be polished in the same content as that of the abrasive grains in the polishing composition and a surface adsorptive agent of the same type and in the same content as those of the surface adsorptive agent in the polishing composition, the amount of the surface adsorptive agent adsorbed to the metallic compound particles in the second suspension is smaller than the amount of the surface adsorptive agent adsorbed to the abrasive grains in the first suspension.

(II) A method for reducing the generation of fine dents like those in orange peel on the surface of a polished object, comprising a crystalline metallic compound, comprising polishing an object by using a polishing composition containing a surface adsorptive agent, abrasive grains, and water, wherein the abrasive grains and the surface adsorptive agent are selected

so as to satisfy the requirement that when a first suspension is prepared that contains abrasive grains and a surface adsorptive agent that are of the same types and in the same contents as those of the abrasive grains and the surface adsorptive agent in the polishing composition, 15% by mass or more of the surface adsorptive agent in the suspension is adsorbed to the abrasive grains in the suspension, and

so as to satisfy the requirement that when a second suspension is prepared that contains particles formed of the same metallic compound as that forming the object to be polished in the same content as that of the abrasive grains in the polishing composition and a surface adsorptive agent of the same type and in the same content as those of the surface adsorptive agent in the polishing composition, the amount of the surface adsorptive agent adsorbed to the metallic compound particles in the second suspension is smaller than the amount of the surface adsorptive agent adsorbed to the abrasive grains in the first suspension.

### EXAMPLES

Next, the embodiment described above will be described in more detail with reference to examples and comparative examples.

### (Preparation of Polishing Composition)

A colloidal silica sol containing colloidal silica having an average primary particle diameter of 80 nm was diluted with water and a surface adsorptive agent was added thereto. Then the value of pH was adjusted to 7 by using nitric acid or potassium hydroxide (pH adjusting agent) to prepare polishing compositions of Examples 1 to 6 and Comparative Example 1. The types and the weight average molecular weights of the surface adsorptive agents contained in the respective polishing compositions are as shown in the “surface adsorptive agent” column in Table 1. In all of the polishing compositions of Examples 1 to 6, the content of colloidal silica was 5% by mass and the content of the surface adsorptive agent was 0.032% by mass.

A colloidal silica sol containing colloidal silica having an average primary particle diameter of 80 nm was diluted with water. Then the value of pH was adjusted to 7 by using a pH adjusting agent to prepare a control polishing composition. The content of colloidal silica in the control polishing composition was 5% by mass and the composition did not contain any surface adsorptive agent.

### (Test of Adsorbability to Silica)

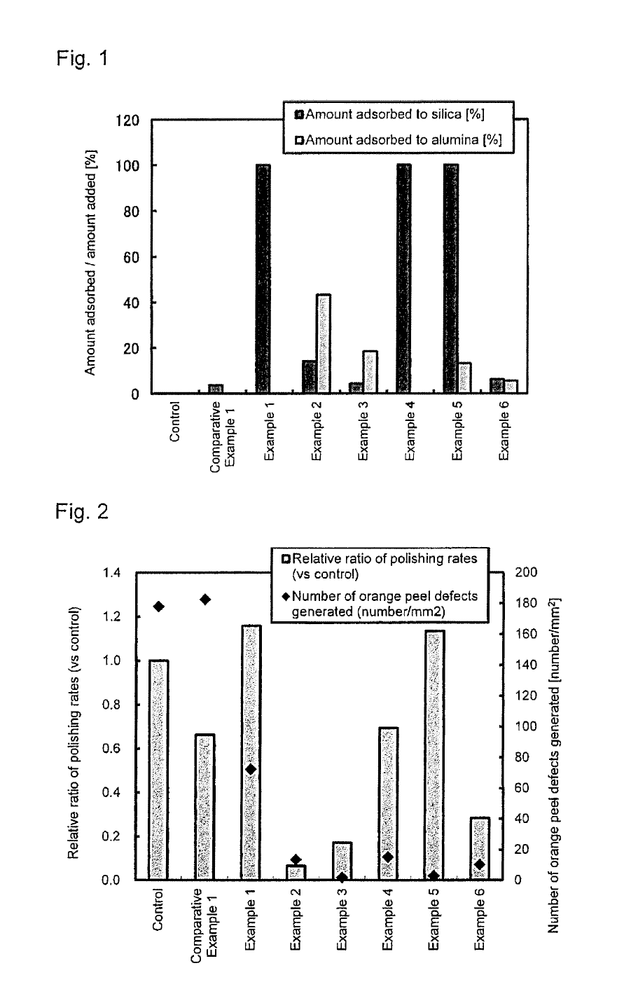

To test the adsorbability of the surface adsorptive agent to silica (SiO₂), which is an example of materials forming abrasive grains, first suspensions were prepared. More specifically, aqueous solutions each of which contained 1.6% by mass of the same surface adsorptive agent as that in one of the polishing compositions of Examples 1 to 6 and Comparative Example 1, and whose pH was adjusted to 7 by using nitric acid or potassium hydroxide, were prepared. 10 g of each of the aqueous solutions and 2.5 g of silica having an average primary particle diameter of 80 nm were mixed with 37.5 g of water to prepare the intended suspensions. The contents of silica and the surface adsorptive agent in each suspension are 5% by mass and 0.032% by mass, respectively, which are the same as those in the polishing compositions of Examples 1 to 6 and Comparative Example 1. The first suspensions were shaken at room temperature (24° C.) for 20 hours and centrifuged at 26,000 rpm for 60 minutes to precipitate silica in the suspensions to obtain supernatant solutions. Next, the total organic carbon (TOC) in each of the resulting supernatant solutions was measured by TOC Analyzer (Shimadzu Corporation, TOC-5000A) to calculate the amount of the surface adsorptive agent remaining in the supernatant solution. From the ratio of the amount of the surface adsorptive agent remaining in the supernatant solution to the total amount added of the surface adsorptive agent, the final amount of the surface adsorptive agent adsorbed to silica was determined. The results are shown in Table 1 and FIG. 1.

### (Test of Adsorbability to Alumina)

To test the adsorbability of the surface adsorptive agent to alumina (Al₂O₃), which is an example of materials forming abrasive grains, second suspensions were prepared. The second suspensions were prepared in the same manner as preparing the first suspensions except for using 2.5 g of alumina having an average primary particle diameter of 400 nm instead of 2.5 g of silica. Also, in the same manner as determining the amount of the surface adsorptive agent adsorbed to silica except for changing the rotational speed in the centrifugation from 26,000 rpm to 3,000 rpm, the final amount of the surface adsorptive agent adsorbed to alumina was determined from the ratio of the amount of the surface adsorptive agent remaining in the supernatant solution to the total amount added of the surface adsorptive agent. The results are shown in Table 1 and FIG. 1.

TABLE 1

| | | | Content | | | | | | |
|---|---|---|---|---|---|---|---|---|---|
| | | | of surface | | | | | | |
| | | | adsorptive | | | | Amount of | | |
| | | | agent | Content | Amount of | Content of | surface adsorptive | | |
| | Surface adsorptive agent | | (% by mass) | of SiO₂ | surface adsorptive | Al₂O₃ | agent adsorbed | | Orange |
| | | Weight | in first | (% by | agent adsorbed to | (% by | to Al₂O₃ (% by | Polishing | peel |
| | | average | suspension | mass) | SiO₂ (% by mass | mass) | mass relative | rate | defects |
| | | molecular | and second | in first | relative to total | in second | to total | (relative to | [number/ |
| | Type | weight | suspension | suspension | amount added) | suspension | amount added) | control) | mm²] |
| Control | — | — | — | 5 | — | 5 | — | 1 | 178 |
| Comparative | Polyethylene glycol | 400 | 0.032 | | 4 | | —* | 0.66 | 183 |
| Example 1 | | | | | | | | | |
| Example 1 | Polyethylene glycol | 8,200 | | | 100 | | —* | 1.16 | 72 |
| Example 2 | Polyacrylic acid | 2,000 | | | 14 | | 43 | 0.06 | 13 |
| Example 3 | Polyacrylic acid | 1,000,000 | | | 4 | | 18 | 0.17 | 2 |
| Example 4 | Polyvinylpyrrolidone | 45,000 | | | 100 | | —* | 0.69 | 15 |
| Example 5 | Polyvinylpyrrolidone | 250,000 | | | 100 | | 13 | 1.13 | 3 |
| Example 6 | Polyvinyl alcohol | 13,000 | | | 6 | | 6 | 0.28 | 10 |
| | (saponification degree | | | | | | | | |
| | 98% by mole or more) | | | | | | | | |

*represents amount adsorbed less than the detection limit

As shown in Table 1 and FIG. 1, it has been shown that the adsorbability of the surface adsorptive agents to silica and to alumina varies greatly depending on their types and weight average molecular weights.

### (Measurement of Polishing Rate and Orange Peel Defects)

Using the respective polishing compositions of Examples 1 to 6, Comparative Example 1, and control, surfaces (C-plane (<0001>) of sapphire substrates were polished in the following conditions. All of the sapphire substrates used have a diameter of 52 mm (about 2 inches) and are of the same type.

The number of orange peel defects generated on the sapphire substrates after polishing using the respective polishing compositions was determined by using a differential interference microscope. Masses of the sapphire substrates before and after the polishing were measured. From the difference between the masses before and after the polishing, polishing rates were determined, and the ratio to the polishing rate of the control polishing composition set to 1 was calculated. The results are shown in Table 1 and FIG. 2.

### <Polishing Conditions of Sapphire Substrate>

Polishing machine: Lens polishing machine available from Udagawa Optical Machines Co. Ltd.

Polishing pad: Nonwoven fabric pad SUBA800 (no groove) available from Nitta Haas Incorporated

Polishing load: 300 g/cm² (29.4 kPa)

Rotation number of bottom plate: 130 rpm

Supply rate of polishing composition: 20 mL/minute (continuously fed without being circulated)

Polishing time: 10 minutes

As shown in Table 1 and FIG. 2, it has been shown that when the surface adsorptive agent has adsorbability to silica or alumina (more specifically when 5% by mass or more of the surface adsorptive agent is adsorbed to silica or alumina relative to the total amount added), surface defects on the sapphire substrate are suppressed. It has also been shown that when 15% by mass or more of the surface adsorptive agent is adsorbed to silica relative to the total amount added, the sapphire substrate is polished at a high polishing rate and surface defects on the sapphire substrate are suppressed. Further, it has been shown that when more surface adsorptive agent is adsorbed to silica than to alumina, the sapphire substrate is likely to be polished at a higher polishing rate.

1. A polishing composition to be used for polishing an object formed of a crystalline metallic compound, comprising abrasive grains, a surface adsorptive agent, and water, wherein the polishing composition reduces defects on a polished surface of the object compared to a composition obtained by excluding the surface adsorptive agent from the polishing composition.

2. The polishing composition according to claim 1, wherein the surface adsorptive agent is at least one selected from the group consisting of a vinyl polymer, a polyalkylene oxide, and a copolymer of a polyalkylene oxide and an alkyl group or an alkylene group.

3. The polishing composition according to claim 1, wherein the abrasive grains and the surface adsorptive agent are selected so as to satisfy the requirement that when a first suspension is prepared that contains abrasive grains and a surface adsorptive agent that are of the same types and in the same contents as those of the abrasive grains and the surface adsorptive agent in the polishing composition, 15% by mass or more of the surface adsorptive agent in the suspension is adsorbed to the abrasive grains in the suspension.

4. The polishing composition according to claim 1, wherein the surface adsorptive agent is selected so as to satisfy the requirement that when a second suspension is prepared that contains particles formed of the same metallic compound as that forming the object to be polished in the same content as that of the abrasive grains in the polishing composition and a surface adsorptive agent of the same type and in the same content as those of the surface adsorptive agent in the polishing composition, the amount of the surface adsorptive agent adsorbed to the metallic compound particles in the second suspension is smaller than the amount of the surface adsorptive agent adsorbed to the abrasive grains in the first suspension.

5. The polishing composition according to claim 1, wherein the abrasive grains are at least one selected from the group consisting of silicon oxide, aluminum oxide, zirconium oxide, cerium oxide, and titanium oxide.

6. The polishing composition according to claim 1, wherein the object to be polished is a single crystal substrate formed of a metal oxide, a metal nitride, or a metal carbide.

7. The polishing composition according to claim 1, wherein the object to be polished is at least one selected from the group consisting of aluminum oxide, aluminum nitride, silicon oxide, silicon nitride, silicon carbide, gallium oxide, gallium nitride, and zirconium oxide.

8. A method for producing a polished substrate, comprising:
providing a substrate formed of a crystalline metallic compound; and
using the polishing composition according to claim 1 to polish the substrate.
